(19) United States
(12) Patent Application Publication
(10) Pub. No.: US 2012/0067156 A1
(43) Pub. Date: Mar. 22, 2012

(54) ROBOT FOR HANDLING OBJECT

(75) Inventors: WEN-SHENG CHEN, Shenzhen City (CN); HAI-YUAN LI, Shenzhen City (CN)

(73) Assignees: HON HAI PRECISION INDUSTRY CO., LTD., Tu-Cheng (TW); HONG FU JIN PRECISION INDUSTRY (ShenZhen) Co., Ltd., Shenzhen City (CN)

(21) Appl. No.: 13/187,709

(22) Filed: Jul. 21, 2011

(30) Foreign Application Priority Data
Sep. 21, 2010 (CN) 201010289350.6

(51) Int. Cl. B25J 18/00; B25J 17/00

(52) U.S. Cl. 74/490.01; 901/27

(57) ABSTRACT

A robot includes a support frame, a first robotic arm, a second robotic arm, a connecting member, a first connecting rod, a second connecting rod, a third connecting rod, a drive connecting rod, an action connecting rod, and an actuator. The first robotic arm is rotatably connected to the support frame. A second robotic arm is rotatably connected to the first robotic arm. A connecting member is rotatably connected to the second robotic arm. A first connecting rod and a second connecting rod connecting with each other to interconnect the connecting member and the second robotic arm. A third connecting rod is rotatably connected to the support frame and the connecting member. A drive connecting rod is rotatably connected to support frame. An action connecting rod connects the drive connecting rod to the second robotic arm. An actuator is connected to the second connecting rod.

### BACKGROUND

1. Technical Field

The present disclosure relates to robots and, particularly, to a robot used for handling objects.

2. Description of Related Art

Many robotic arms include a fixed base, a frame pivotably connected to the fixed base about a first rotation axis, a first segment, one end of which is pivotably connected to the frame about a second rotation axis, and a second segment, one end of which is pivotably connected to the other end of the first segment about a third rotation axis. An actuator, such as a detector, a welding device, a gripper or a cutting tool, is mounted at a distal end of the second segment of the industrial robot to execute specific tasks. Generally, several axes are utilized to achieve maximum movement of the actuator.

In robots of this kind, each arm rotates around a rotation axis driven by a driving unit. Typically, the driving unit includes a motor mounted on the first segment and a speed reducer coupled to the motor to transmit the movement of the motor to the second segment. However, the robotic arm generally has a large axial size due to the presence of the motor and speed reducer, and a load weight of the robotic arm is relatively low.

Therefore, there is room for improvement within the art.

### BRIEF DESCRIPTION OF THE DRAWINGS

The components in the drawings are not necessarily drawn to scale, the emphasis instead placed upon clearly illustrating the principles of the present disclosure. Moreover, in the drawings, like reference numerals designate corresponding parts throughout the several views.

FIG. 1 is an assembled, isometric view of an exemplary embodiment of a robot.

FIG. 2 is similar to FIG. 1, but viewed from another aspect.

FIG. 3 is a schematic for a simplified view of the robot of FIG. 1.

### DETAILED DESCRIPTION

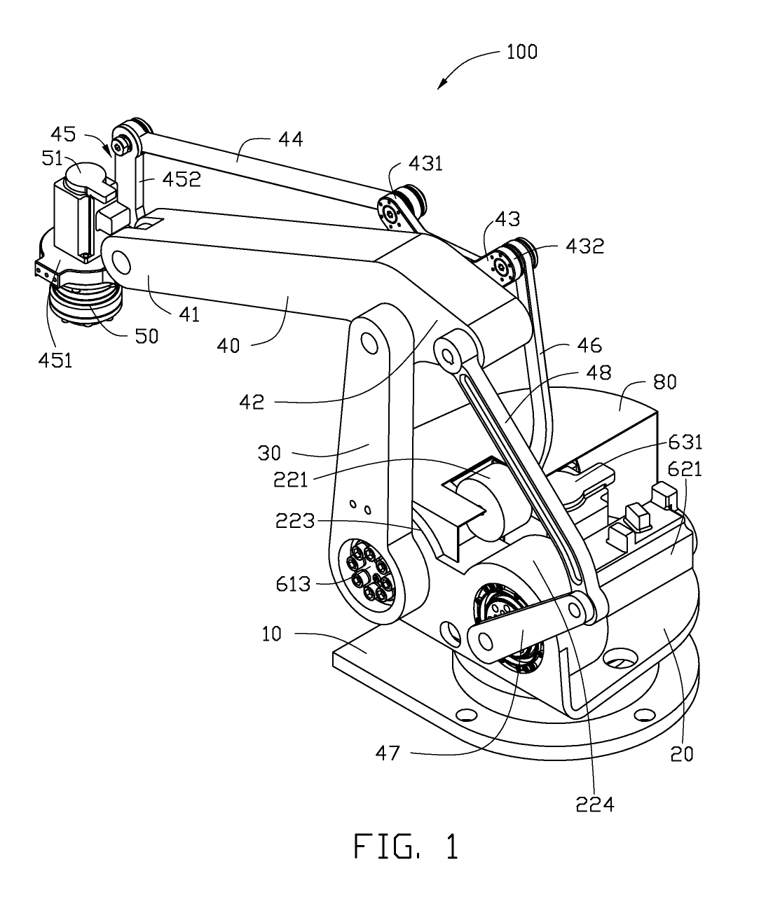

Referring to FIGS. 1 through 3, an exemplary embodiment of a robot 100 includes a base 10, a support frame 20 rotatably positioned on the base 10, a first robotic arm 30 rotatably connected to the support frame 20, a second robotic arm 40 rotatably connected to the first robotic arm 30, and an actuator 50 positioned on the second robotic arm 40. The second robotic arm 40 forms a first connecting portion 41 and a second connecting portion 42 on opposite ends thereof. The actuator 50 is assembled to the first connecting portion 41, and the first robotic arm 30 is rotatably connected to the second connecting portion 42.

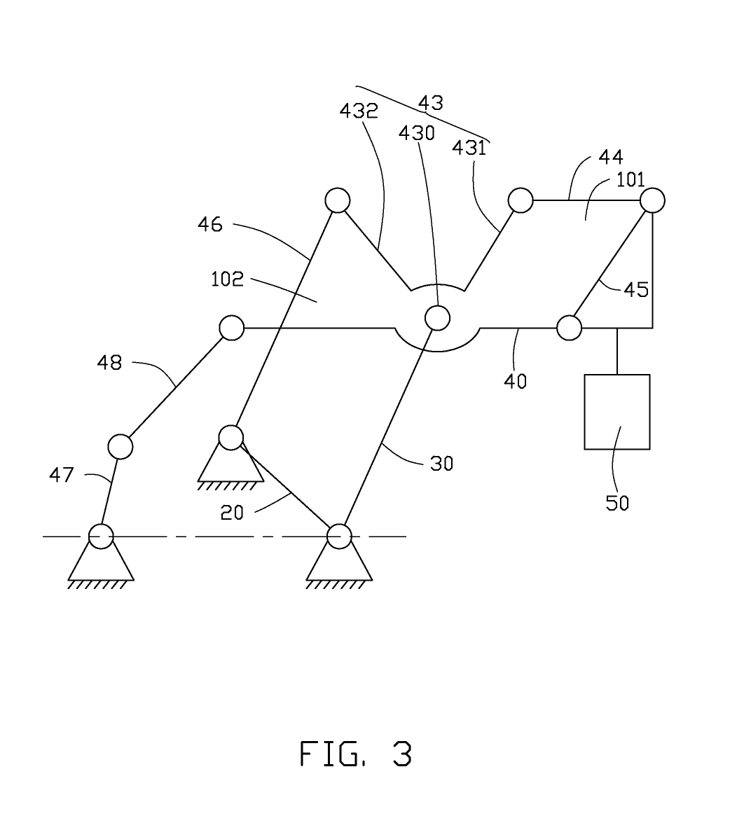

A connecting member 43 is connected to the second connecting portion 42. A first connecting rod 44 and a second connecting rod 45 are rotatably connected with each other to interconnect the connecting member 43 and the first connecting portion 41. The connecting member 43, the first connecting rod 44, the second connecting rod 45, and the second robotic arm 40 cooperatively form a first parallelogram frame 101 (as shown in FIG. 3). The actuator 50 is connected to the second connecting rod 45.

A third connecting rod 46 is connected between the support frame 20 and the connecting member 43. Opposite ends of the third connecting rod 46 are rotatably connected to the support frame 20 and the connecting member 43, respectively. The connecting member 43, the first robotic arm 30, the third connecting rod 46, and the support frame 20 cooperatively form a second parallelogram frame 102 (as shown in FIG. 3). The actuator 50 can maintain the orientation relative to the support frame 20, because the actuator 50 is restricted by both of the first parallelogram frame 101 and the second parallelogram frame 102.

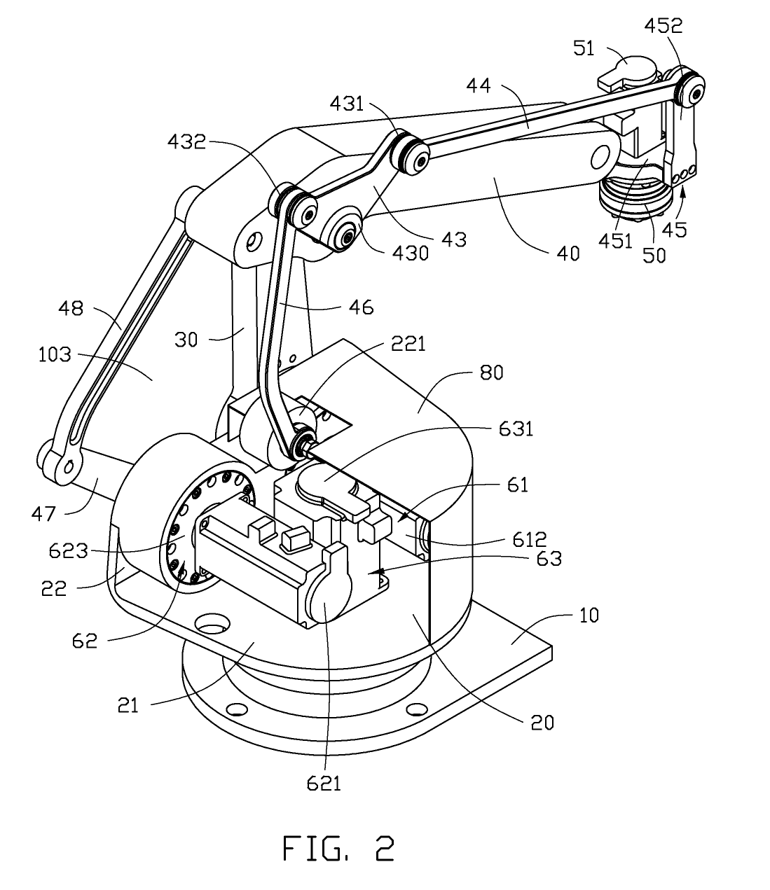

In the illustrated embodiment, referring to FIG. 2 again, the connecting member 43 includes a shaft portion 430, a first connecting end 431, and a second connecting end 432. The first connecting end 431 and the second connecting end 432 extend from the shaft portion 430 in two different directions. In the illustrated embodiment, the first connecting end 431 and the second connecting end 432 cooperatively define a L-shaped structure. The shaft portion 430 is rotatably connected to the second robotic arm 40. The first connecting end 431 is rotatably connected to the first connecting rod 44, and the second connecting end 432 is rotatably connected to the third connecting rod 46.

The second connecting rod 45 includes an assembly plate 451, and a support bar 452 substantially perpendicularly fixed to the assembly plate 451. The assembly plate 451 is rotatably connected to the first connecting portion 41 of the second robotic arm 40, and the support bar 452 is rotatably connected to the first connecting rod 44. The actuator 50 is connected to the assembly plate 451.

A drive connecting rod 47 and an action connecting rod 48 are connected with each other to interconnect the support frame 20 and the second robotic arm 40. The drive connecting rod 47, the action connecting rod 48, the second robotic arm 40, the first robotic arm 30 and the support frame 20 cooperatively form a pentagonal frame 103 (as shown in FIG. 2). The connecting member 43, the first connecting rod 44, the second connecting rod 45, and a third connecting rod 46 are positioned at one side of the second robotic arm 40, and the drive connecting rod 47 and the action connecting rod 48 are positioned at the opposite side of the second robotic arm 40.

The robot 100 further includes a first driving assembly 61 driving the first robotic arm 30, a second driving assembly 62 driving the drive connecting rod 47, and a third driving assembly 63 driving the support frame 20. The first driving assembly 61 and the second driving assembly 62 are positioned on the support frame 20. The third driving assembly 63 is positioned on the support frame substantially between the first driving assembly 61 and the second driving assembly 62. A load weight of the second robotic arm 40 is relatively low, and the second robotic arm 40 is easily controlled, because the second driving assembly 62 driving the second robotic arm 40 is positioned on the support frame 20. The actuator 50 further comprises a rotation motor 51 driving the actuator 50 to rotate.

In the illustrated embodiment, the support frame 20 includes a bottom plate 21 and a side plate 22 extending from an edge of the bottom plate 21. A connecting base 221 is fixed on the side plate 22, and an end of the third connecting rod 46 is rotatably connected to the connecting base 221. The side plate 22 further includes a first assembly portion 223 and a second assembly portion 224 on opposite sides of the connecting base 221.

The first driving assembly 61 includes a first motor 612 and a first speed reducing module 613. The first motor 612 is fixedly positioned on the bottom plate 21, and the first speed reducing module 613 is positioned on the first assembly portion 223. The second driving assembly 62 includes a second motor 621 and a second speed reducing module 623. The second motor 621 is fixedly positioned on the bottom plate 21, and the second speed reducing module 623 is positioned on the second assembly portion 224. The third driving assembly 63 includes a third motor 631 and a third speed reducing module (not shown). The third motor 631 is positioned substantially between the first motor 612 and the second motor 621.

The robot 100 further includes a protection housing 80 coupled to the support frame 20. The first motor 612, the second motor 621, and the third motor 631 are received in the protection housing 80, thus protecting the first motor 612, the second motor 621, and the third motor 631 from being polluted by dust and oil. As a result, a service life of the three motors 612, 621, 631 is increased. In addition, the protection housing 80 can be made of transparent material.

Referring again to FIGS. 1-3, because the support frame 20, the first robotic arm 30, the second connecting end 432 of the connecting member 43, and the third connecting rod 46 cooperatively form the second parallelogram frame 102; an orientation of the second connecting end 432 relative to the support frame 20 is not changed when the first robotic arm 30 is driven to rotate by the first motor 612. Because the first connecting end 431 of the connecting member 43, the first connecting rod 44, the second connecting rod 45, and the second robotic arm 40 cooperatively form the first parallelogram frame 101, an orientation of the second connecting rod 45 relative to the first connecting end 431 is not changed, when the second robotic arm 40 is driven to rotate by the action connecting rod 48. That is, an orientation of the actuator 50 relative to the first connecting end 431 is not changed. Thus, an orientation of the actuator 50 relative to the support frame 20 is also not changed. As a result, the actuator 50 can stably handle or manipulate objects (not shown) without shaking, because the orientation of the actuator 50 is fixed. Furthermore, the actuator 50 can be driven to rotate in a level plane by the rotation motor 51.

It is believed that the present embodiments and their advantages will be understood from the foregoing description, and it will be apparent that various changes may be made thereto without departing from the spirit and scope of the disclosure or sacrificing all of its material advantages.

What is claimed is:

1. A robot, comprising:
a support frame;
a first robotic arm rotatably connected to the support frame; and
a second robotic arm rotatably connected to the first robotic arm;
a connecting member rotatably connected to the second robotic arm;
a first connecting rod and a second connecting rod connecting with each other to interconnect the connecting member and the second robotic arm;
a third connecting rod rotatably connected to the support frame and the connecting member;
a drive connecting rod rotatably connected to support frame;
an action connecting rod connecting the drive connecting rod to the second robotic arm;
an actuator connected to the second connecting rod;
wherein the connecting member, the first connecting rod, the second connecting rod, and the second robotic arm cooperatively form a first parallelogram frame; the connecting member, the first robotic arm, the third connecting rod, and the support frame cooperatively form a second parallelogram frame.

2. The robot of claim 1, further comprising a first driving assembly for driving the first robotic arm to rotate, a second driving assembly for driving the drive connecting rod to rotate, wherein the first driving assembly and the second driving assembly are positioned on the support frame.

3. The robot of claim 1, wherein the connecting member comprises a shaft portion, a first connecting end, and a second connecting end, the first connecting end and the second connecting end extend from the shaft portion in two different directions; the shaft portion is rotatably connected to the second robotic arm, the first connecting end is rotatably connected to the first connecting rod, and the second connecting end is rotatably connected to the third connecting rod.

4. The robot of claim 2, further comprising a base connected to the support frame and a third driving assembly for driving the support frame to rotate relative to the base, wherein the third driving assembly is positioned between the first driving assembly and the second driving assembly.

5. The robot of claim 4, further comprising a protection housing, wherein the first driving assembly, the second driving assembly and the third driving assembly are received in the protection housing.

6. The robot of claim 5, wherein the protection housing is made of transparent materials.

7. The robot of claim 5, wherein the support frame comprises a bottom plate and a side plate extending from an edge of the bottom plate, a connecting base is fixed on the side plate, and an end of the third connecting rod is rotatably connected to the connecting base.

8. The robot of claim 7, wherein the side plate forms a first assembly portion and a second assembly portion on opposite sides of the connecting base; the first driving assembly comprises a first motor and a first speed reducing module, the first motor is fixedly positioned on the bottom plate, and the first speed reducing module is positioned on the first assembly portion; the second driving assembly comprises a second motor and a second speed reducing module, the second motor is fixedly positioned on the bottom plate, and the second speed reducing module is positioned on the second assembly portion.

9. The robot of claim 1, wherein the connecting member, the first connecting rod, the second connecting rod, the third connecting rod are positioned at one side of the second robotic arm; the drive connecting rod and the action connecting rod are positioned at the other side of the second robotic arm.

10. The robot of claim 1, wherein the actuator comprises a rotation motor driving the actuator to rotate relative to the second connecting rod.

11. A robot, comprising:
a support frame;
a first robotic arm rotatably connected to the support frame; and
a second robotic arm rotatably connected to the first robotic arm;
a connecting member rotatably connected to the second robotic arm;
a first connecting rod and a second connecting rod connecting with each other to interconnect the connecting member and the second robotic arm;
a third connecting rod rotatably connected to the support frame and the connecting member;
a drive connecting rod rotatably connected to support frame;
an action connecting rod connecting the drive connecting rod to the second robotic arm;
an actuator connected to the second connecting rod;
a first driving assembly for driving the first robotic arm to rotate; and
a second driving assembly for driving the second robotic arm to rotate.

12. The robot of claim 11, wherein the connecting member comprises a shaft portion, a first connecting end, and a second connecting end, the first connecting end and the second connecting end extend from the shaft portion in two different directions ; the shaft portion is rotatably connected to the second robotic arm, the first connecting end is rotatably connected to the first connecting rod, and the second connecting end is rotatably connected to the third connecting rod.

13. The robot of claim 11, further comprising a base and a third driving assembly for driving the support frame to rotate relative to the base, wherein the third driving assembly is positioned between the first driving assembly and the second driving assembly.

14. The robot of claim 13, further comprising a protection housing, wherein the first driving assembly, the second driving assembly and the third driving assembly are received in the protection housing.

15. The robot of claim 14, wherein the protection housing is made of transparent materials.

16. The robot of claim 15, wherein the support frame comprises a bottom plate and a side plate extending from an edge of the bottom plate, a connecting base is fixed on the side plate, and an end of the third connecting rod is rotatably connected to the connecting base.

17. The robot of claim 16, wherein the side plate forms a first assembly portion and a second assembly portion on opposite sides of the connecting base; the first driving assembly comprises a first motor and a first speed reducing module, the first motor is fixedly positioned on the bottom plate, and the first speed reducing module is positioned on the first assembly portion; the second driving assembly comprises a second motor and a second speed reducing module, the second motor is fixedly positioned on the bottom plate, and the second speed reducing module is positioned on the second assembly portion.

18. The robot of claim 11, wherein the connecting member, the first connecting rod, the second connecting rod, the third connecting rod are positioned at one side of the second robotic arm; the drive connecting rod and the action connecting rod are positioned at the other side of the second robotic arm.

19. The robot of claim 11, wherein the actuator comprises a rotation motor driving the actuator to rotate relative to the second connecting rod.
